(19) United States
(12) Patent Application Publication
(10) Pub. No.: US 2024/0137852 A1
(43) Pub. Date: Apr. 25, 2024

(54) NETWORK SERVICE PLAN SELECTION FOR DELIVERY OF NETWORK SERVICES

(71) Applicant: Telefonaktiebolaget LM Ericsson (publ), Stockholm (SE)

(72) Inventors: Purusottam Kumar JHA, Ghaziabad (IN); Saurabh GUPTA, Etawah (IN); Yatin RAJWADHA, Noida (IN); Robert TÖRNKVIST, Karlskrona (SE)

(21) Appl. No.: 18/278,455

(22) PCT Filed: Feb. 24, 2021
(86) PCT No.: PCT/SE2021/050151

§ 371 Date: Aug. 22, 2023

(51) Int. Cl. H04W 48/18; H04W 4/12; H04W 76/40

(52) U.S. Cl. CPC H04W 48/18; H04W 4/12; H04W 76/40

(57) ABSTRACT

A method is disclosed for handling delivery of network-delivered services to a user equipment, UE, in a wireless communication network. The method is performed by at least one network node in the wireless communication network. The method includes receiving a service request associated with a network-delivered service from the UE. The method includes notifying one or more service plans related the service request to the UE, in response to the service request. The method includes receiving a user selection order from the UE, wherein the user selection order identifies a selection of at least one of the one or more service plans from the one or more service plans. Further, the method includes initiating the network-delivered service in accordance with the user selection order. Corresponding network node, user equipment and computer program product are also disclosed.

### TECHNICAL FIELD

The present disclosure relates generally to the field of wireless communication. More particularly, to a method and a network node for handling delivery of network-delivered services to a user equipment, UE, in a wireless communication network.

### BACKGROUND

Typically, network operators and service providers provide various services to users based on a pre-paid pricing scheme. For example, a user may pay a monthly fee for a particular service that may allow the user unlimited use of the service or a limited use of the service.

In modern telecommunication networks, service price determination functions, also referred to as charging functions, are split into a service domain comprising service providing nodes and a charging domain comprising a central charging system. The charging functions in the service nodes provide information about the usage of network services to the central charging system. Charging information for network resource usage is collected in parallel along with the network resource usage. In this, authorization for resource usage is obtained by the network from a Charging Function, CHF, as a precondition for allowing the actual resource utilization. For this a network node (e.g. SMF of 5G) communicates with CHF using agreed protocols.

When a network service is requested from a user equipment (for example, via webpage, app etc.), the network sends a request to CHF for credit authorization so that requested service can be charged. The credit authorization for requested network service is performed from a network service plan or a tariff plan subscribed or purchased by the user. It may be possible that user has purchased multiple service plans for the network service and all the service plans are eligible for credit authorization for the requested network service. In such case, the CHF determines the service plan that should be used for the credit authorization of requested service. For example, the CHF may use arbitrary selection rules or a pre-determined mechanism for charging the requested service such as the service plan expiring first be consumed first, or the service plan purchased first be consumed first, or the service plan purchased last be consumed first or a high speed data product should be consumed first.

### SUMMARY

An object of the present disclosure is to provide an improved mechanism for handling delivery of network-delivered services.

This and other objects are achieved by means of a method, a network node, and a computer program product as defined in the appended claims. The term exemplary is in the present context to be understood as serving as an instance, example or illustration.

According to a first aspect of the present disclosure, there is provided a method for handling delivery of network-delivered services to a user equipment, UE, in a wireless communication network. The method is performed by at least one network node. The method comprises receiving a service request associated with a network-delivered service from the UE, notifying one or more service plans related to the service request to the UE, in response to the service request. The method comprises receiving a user selection order from the UE, wherein the user selection order identifies a selection of at least one of the one or more service plans from the one or more service plans. Further, the method comprises initiating the network-delivered service in accordance with the user selection order.

In some embodiments, the method further comprising identifying the one or more service plans related to the service request prior to notifying the one or more service plans, wherein the one or more service plans are associated with the network-delivered service subscribed by the UE.

In some embodiments, the step of notifying one or more service plans related to the service request to the UE comprises transmitting information relating to the one or more service plans in a format suitable for a user interface, UI, of the UE, wherein the user selection order is received from the UI of the UE.

In some embodiments, the user selection order further comprises one or more criteria for each user selected service plan, wherein the one or more criteria comprises a bandwidth requirement and/or a time period indicating a number of hours or a time of a day.

In some embodiments, the method further comprises storing the user selection order received from the UE.

In some embodiments, the network-delivered service is a subscription based service comprising one or more of a data service, a voice service, a multimedia broadcast multicast service, MBMS, and over-the-top, OTT service.

In some embodiments, the network node is a network function, such as a charging function, CHF in a core network, CN, wherein the user selection order from the UE is received via another network node in the wireless communication network.

According to a second aspect of the present disclosure, there is provided a network node for handling delivery of network-delivered services in a wireless communication network.

The network node comprising a processor, and a memory storing instructions when executed by the processor cause the network node to: receive a service request associated with a network-delivered service from the UE; notify one or more service plans related to the service request to the UE, in response to the service request. Further, the instructions when executed by the processor cause the network node to receive a user selection order from the UE, wherein the user selection order identifies a selection of at least one of the one or more service plans from the one or more service plans and initiate the network-delivered service in accordance with the user selection order.

According to a third aspect of the present disclosure, there is provided a method for handling delivery of network-delivered services by a user equipment, UE, in a wireless communication network. The method is performed by the UE. The method comprises transmitting a service request associated with a network-delivered service to a network node in the wireless communication network. The method comprises receiving one or more service plans related to the service request from the network node, in response to the transmission of the service request. The method comprises transmitting a user selection order to the network node, wherein the user selection order identifies a selection of at least one of the one or more service plans from the one or more service plans. Further, the method comprises initiating the network-delivered service in accordance with the user selection order.

According to a fourth aspect of the present disclosure, there is provided a user equipment, UE, for handling delivery of network-delivered services in a wireless communication network. The UE comprising a processor and a memory storing instructions that, when executed by the processor, cause the UE to transmit a service request associated with a network-delivered service to a network node in the wireless communication network; receiving one or more service plans related to the service request from the network node, in response to the transmission of the service request. Further, the instructions when executed by the processor, cause the UE to transmit a user selection order to the network node, wherein the user selection order identifies a selection of at least one of the one or more service plans from the one or more service plans and initiate the network-delivered service in accordance with the user selection order.

According to a fifth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

An advantage of some embodiments is that alternative and/or improved approaches for handling delivery of network-delivered services to the UE.

An advantage of some embodiments is that the proposed method allows a dynamic flexibility to the user to select an order of the purchased service plans such that a requested network service can be provided according to the user selection order of the service plans.

In some embodiments, the proposed method allows the user to change the service plan order dynamically when a network service request is initiated.

An advantage of some embodiments is that the proposed method allows the user to define one or more criteria for each user selected service plan. The one or more criteria comprises a bandwidth requirement for each service plan and a time period for each service plan, or the like.

An advantage of some embodiments is that the proposed method allows the user to select specific service plans in real-time according to the user convenience services, which enhances the user satisfaction towards the network-delivered services.

An advantage of some embodiments is that the proposed method allows the network operators to have higher consumption of service or product offerings due to multiple service activation by the subscribers or the users which improves the average revenue per subscriber, ARPU.

Advantageously, the proposed method can be readily implemented in the network node or a remoted computer located in a cloud environment or a remote server in a cloud network. Further, the proposed method can be implemented using software-as-a-service model in case of managed services.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 illustrates components of a wireless communication network for handling delivery of network-delivered services according to some embodiments;

FIG. 2 is a flowchart illustrating example method steps performed by a network node according to some embodiments;

FIG. 3 is an example sequence diagram according to some embodiments;

FIG. 4 is a flowchart illustrating example scenario in which a network node delivers the services in accordance with user selection order according to some embodiments;

FIG. 5 is a schematic block diagram illustrating an example network node according to some embodiments;

FIG. 6 is a flow chart illustrating example method steps performed by a user equipment according to some embodiments;

FIG. 7 is a schematic block diagram illustrating an example user equipment according to some embodiments; and

FIG. 8 discloses an example computing environment according to some embodiments;

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the present disclosure, user equipments, UEs, also known as mobile terminals, and/or wireless terminals are enabled to communicate wirelessly with a network node, for example, a charging function, CHF, in a wireless communication network.

In the present disclosure, it is assumed that connection establishment has already been completed between the UE(s) and the network node.

In the following description of exemplary embodiments, the same reference numerals denote the same or similar components.

The following aspects have been presented herein for better understanding of various embodiments of the present disclosure.

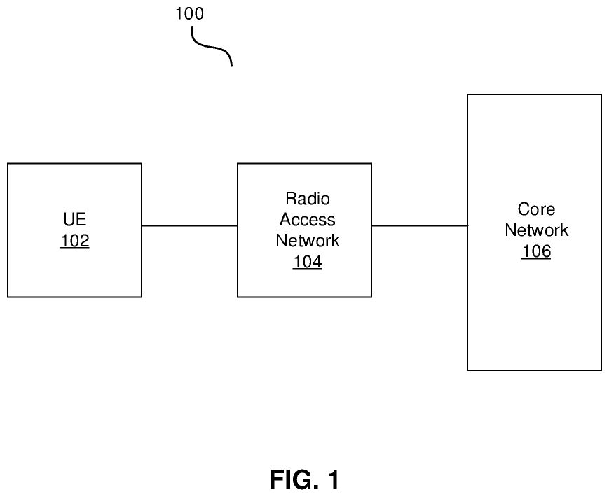

FIG. 1 illustrates components of a wireless communication network 100 for handling delivery of network-delivered services according to some embodiments. The wireless communication network 100 comprises a User Equipment, UE 102, an Access Network, AN 104 and a Core Network, CN 106. The UE 102 may be an electronic device that connects to the AN 104. An example of the AN 104 is a Radio Access Network, RAN. The CN 104 may include a Control Plane CP 132 and a User Plane, UP 134 (not shown in FIG. 1). The UE 102 communicates with one or more network nodes or service nodes in the CN 104 typically to obtain a network-delivered service via connections through a node in the RAN 102 and then through the CN 104. Packet Data Units, PDUs, between the UE 102 and the network node in the CN 106 are transmitted through the AN 104 and the CN 106.

The UE 103, the AN 104 and the CN 106 are interconnected to enable delivery of and accounting for usage of various network-delivered services according to one or more service plans designed by a network operator.

In an example, the service plans may include tariff plans which are specifically designed and are offered on or made available to a specified collection of UEs, where the service plans can be used to define a wide variety of service plans, possibly time-limited, such as a plan that offers voice service and/or messaging service up to a specified usage limit (e.g., specified minutes of voice and/or number of texts), or a service plan that offers access through a particular end user device application (“app”). For example, a service plan that allows unlimited use of a Social Networking Site, SNS app for a day, or a plan that offers access to a particular website for a specified period of time, etc.), or a plan that offers access to a particular type of content (e.g., streaming content, video content, audio content, etc.), or a plan that offers access to a particular category of services (e.g., access to social networking services through specified apps and web sites), or the like.

Functionally, a service processor, implemented in hardware, software, or a combination of hardware and software, within the UE 102 and a service controller, implemented in hardware, software, or a combination of hardware and software, within one or more of the network elements in the AN 104 or CN 106 communicate over a link to enable and account for service usage (e.g., voice, data, messaging, etc.), and to enable on-demand purchasing of various service plans via a user-interface, UI, of the UE 102. In the UI, the UE 102 presents various voice, messaging, data and specialized application and/or service plans to choose from a list of available service plans. The service processor communicates the selection of a service plan and information about ongoing service usage within a selected plan to service controller which coordinates with other network operation elements and/or elements within the access/core networks to configure the selected service plan and deliver the requested service. The service controller obtains service usage information from the service processor and/or one or more network elements (e.g., base station, radio access network (RAN) gateway, transport gateway, mobile wireless center, home location register, AAA server, data store, etc.) and communicates service usage information to billing infrastructure elements as necessary to account for service usage.

A network node represented as charging function, CHF, in the CN 106 provides information about the usage of network services to the central charging system. Charging information for network resource usage is collected in parallel along with the network resource usage. In this, authorization for resource usage is obtained by the network from the CHF, as a precondition for allowing the actual resource utilization. Credit authorization for requested network service is performed from a service plan selected or purchased by the user.

In case, when the user has purchased multiple service plans for a particular network service then all the service plans are eligible for credit authorization for the requested network service. In such case, the CHF determines the service plan that should be used for the credit authorization of requested service. For example, the CHF may use arbitrary selection rules or a pre-determined mechanism for charging the requested service such as the service plan expiring first be consumed first, or the service plan purchased first be consumed first or the like. Therefore, the user cannot have a flexibility for selecting a desired service plan and further lacks a mechanism for choosing a service plan selection order such that the requested network service be charged according to the user selection of the service plans.

Thus, some embodiments of the present disclosure provides a dynamic flexibility to allow the user to select an order of the purchased service plans such that the requested network service can be charged according to the user selection order of the service plans.

Further, some embodiments of the present disclosure enables the user to select the service plan order dynamically for a given network service when a network service request is initiated.

Some embodiments of the present disclosure enables the user to define one or more criteria for each user selected service plan. The one or more criteria comprises a bandwidth requirement for each service plan and/or a time period indicating a number of hours or a time of a day for each service plan, or the like.

The embodiments of the present disclosure can be readily implemented in any of the network nodes in the core network or a remoted computer located in a cloud environment or a remote server in a cloud network.

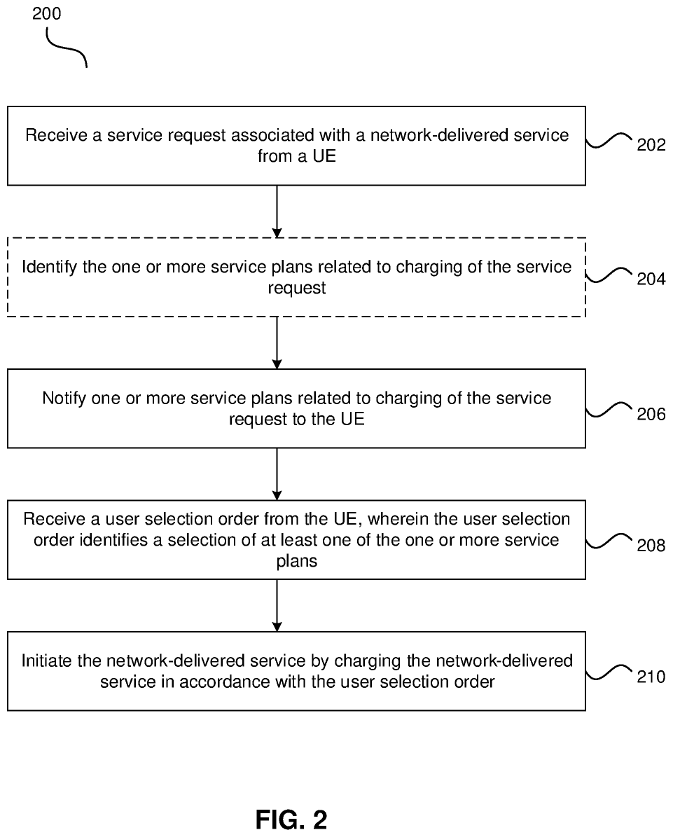

FIG. 2 is a flowchart illustrating example method 200 according to some embodiments.

The method 200 is for handling delivery of the network-delivered services to the UE. A typical example where the method 200 may be applicable is for charging a user in a scenario where the user has subscribed for multiple service plans for a given network service and for example, during the delivery of a service (for example, a video content) to the UE over the wireless communication network.

The network-delivered service can be a subscription based service comprising one or more of a data service, a voice service, a multimedia broadcast multicast service, MBMS, and over-the-top, OTT service, or the like.

In some examples, the method 200 may be applicable when the UE subscribes for user selection order of service plans for charging the UE.

For example, the method 200 may be performed by a network node (e.g., the network node may be present in CN 106 in FIG. 1) and/or in a CHF in the CN 106 in FIG. 1. The network node is a network function i.e., the CHF in the CN 106.

Further, the network node, can be for example, a remote computer or a server hosted in the wireless communication network 100 in FIG. 1. The steps illustrated in FIG. 2 may be performed for one network node, for some network nodes, or for each network node in the CN 106 in FIG. 1.

In some embodiments, the method 200 may be performed by the network nodes residing in a cloud network. At step 202, the method 200 comprises receiving a service request associated with the network-delivered service from the UE.

In some examples, the network node receives the service request through an application function, AF, in the UE. For example, the AF may be a client application or a webpage within the UE which sends the service request from the UE to the network node.

The service request to the network node indicates that the UE is intended to obtain the network-delivered services which may include but not limited to a subscription based service comprising one or more of a data service, a voice service, a multimedia broadcast multicast service, MBMS, and over-the-top, OTT service, which may be time-limited as per the service plans designed by network operators. It should be noted that the service request may be different for each service or may be same for a group of services as configured or implemented according to the service plans.

At step 206, the method 200 comprises notifying one or more service plans related to the service request.

For example, the network node notifies the UE about the service plans related the service request. The AF within the UE displays or notifies the service plans to the user.

In an embodiment, the network node transmits information relating to the one or more service plans in a format suitable for a user interface, UI, of the UE and the user selection order is received from the UI of the UE.

In some examples, the notified service plans to the user are the default order of the service plans which are used by the network node for charging the user for accessing the network-delivered services.

Thus, in response to the service request received from the UE, at step 202, the network node notifies the service plans and/or default ordering of the service plans that are used by the network node for initiating the network-delivered services.

In an embodiment, the method 200 comprises identifying one or more service plans related to the service request prior to notifying the one or more service plans to the UE, as illustrated by the optional step 204.

The network node identifies the one or more service plans subscribed or purchased by the UE. Typically, the network node maintains the information related to the one or more service plans subscribed or purchased by the UE and therefore, in response to receiving the service request from the UE, the network node identifies the one or more service plans.

At step 208, the method 200 comprises receiving a user selection order from the UE. The user selection order identifies a selection of at least one of the one or more service plans.

In some embodiments, the network node may receive the user selection order from the UE by indicating the one or more service plans associated with the service request to the UE and the network node may receive the user selection order identifying the selection of the one or more service plans.

In some examples, a user interface, UI, may be provided for receiving the user selection order from the UE. The UI may include the default order of the service plans and the user may select the order of the service plans for crediting or charging the service request from the user selected order of the service plans. Thus, the user selection order received from the UE includes a selection of least one service plan from the one or more service plans or an ordering of the service plans to be used for charging the user for the service request.

It should be noted that the user may select a single service plan from a set of service plans to be used for charging the user for the service request or the user may select multiple service plans, or preferably the user may select an order of the service plans according to real-time requirements for charging the user for the service request.

At step 210, the method 200 comprises initiating the network-delivered service in accordance to the user selection order.

In some examples, charging the user for the service request may be performed according to the user selection order that includes the order of the service plans and the network node utilizes the user selection order of the service plans for charging the user during delivery of the network-delivered services to the UE.

Therefore, unlike to the conventional systems, where the network node performs charging of the user based on rule based selection of service plans at the network node, with the embodiments of the present disclosure, the user can select one or more service plans to be used by the network node for charging the user for the service request.

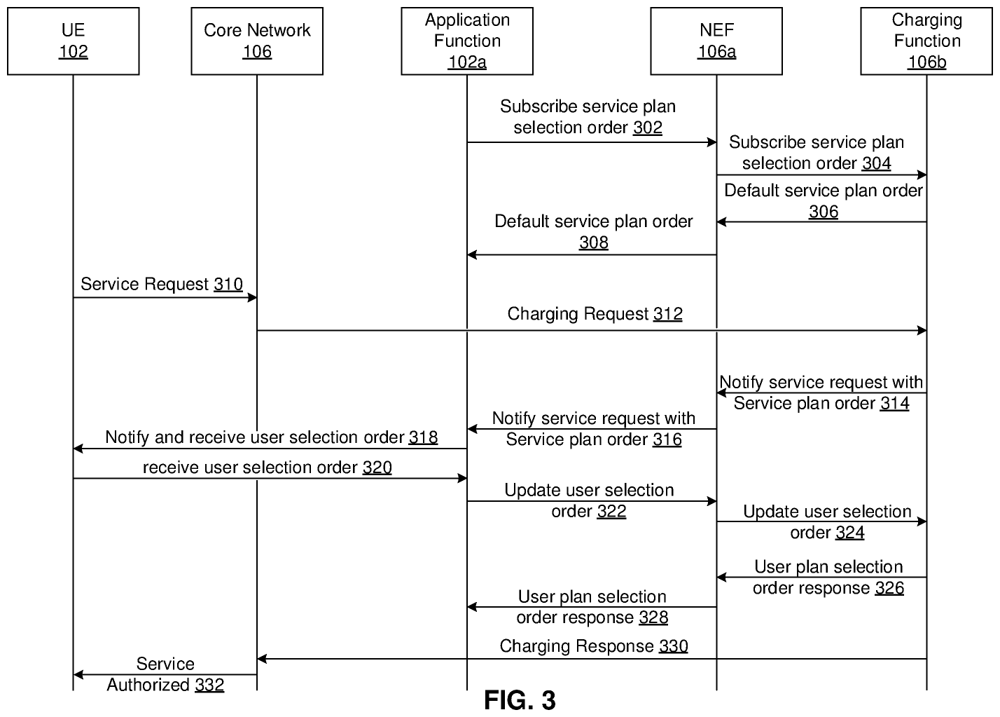

FIG. 3 is an example sequence diagram according to some embodiments. As depicted in the FIG. 3, various entities involved in handling the delivery of network-delivered services in the wireless communication network include UE 102, AF 102a (residing at UE 102), CN 106, network elements or entities in CN 106 such as network exposure function, NEF 106a and CHF 106a.

Initially, as stated above, the UE 102 UE subscribes for user selection order of service plans for charging the UE 102. In order to subscribe for user selection order of service plans for charging the UE 102, the UE 102 transmits 302 a request to subscribe for service plan selection order. The NEF receives the request for subscription from the UE and then the NEF forwards 304 the request for subscription for service plan selection order to the CHF 106b.

The CHF 106b, in response to the request from NEF 106a, transmits 306 a default order of the service plans to the NEF 106a and the NEF 106a in turn transmits 308 the default order of the service plans to the AF 102a at the UE 102. Thus, the subscription procedure for user selection order of service plans for charging the UE 102 is said to be complete when the AF 102a receives the default order of the service plans from the CHF 106b.

Once the UE 102 has completed the subscription for user selection order of the service plans, the UE 102 may transmit 310 a service request to the CN 106 for requesting any of the network-delivered service. When the CN 106 receives the service request associated with the network-delivered service, the CN 106 transmits 312 a request to the CHF 106b for charging the service request.

The CHF 106b transmits 314 a notification with a default order of the one or more service plans related to the service request to the NEF 106a. The NEF 106a transmits 316 the notification with a default order of the one or more service plans to the AF 102a. Further, the AF 102a notifies 318 the UE 102, may be in a UI, the default order of the one or more service plans.

The UE 102 transmits 320 a request to receive the user selection order of the service plans to the AF 102a. Here, the user, through the AF 102a transmits the request to change or update the order of the service plans. Further, the AF 102a transmits 322 a request for change or update of the order of the service plans to the NEF 106a and the NEF 106a in turn forwards 324 the request to the CHF 106b.

The CHF 106b responds 326 to the NEF 106a with an updated user selection order of the service plans for charging the user and the NEF 106a forwards 328 the updated user selection order to the AF 102a and the AF 102a indicates the UE 102a about the user selection order of the service plans. Further, the CHF 106b transmits 330 a charging response to the CN 106 and thereby the CN 106 authorizes 332 the service to the UE 102 Further, the requested service corresponding to the service requested is delivered to the UE 102.

It should be noted that the CHF 106b performs the charging for the requested service in accordance to the user selection order of the service plans.

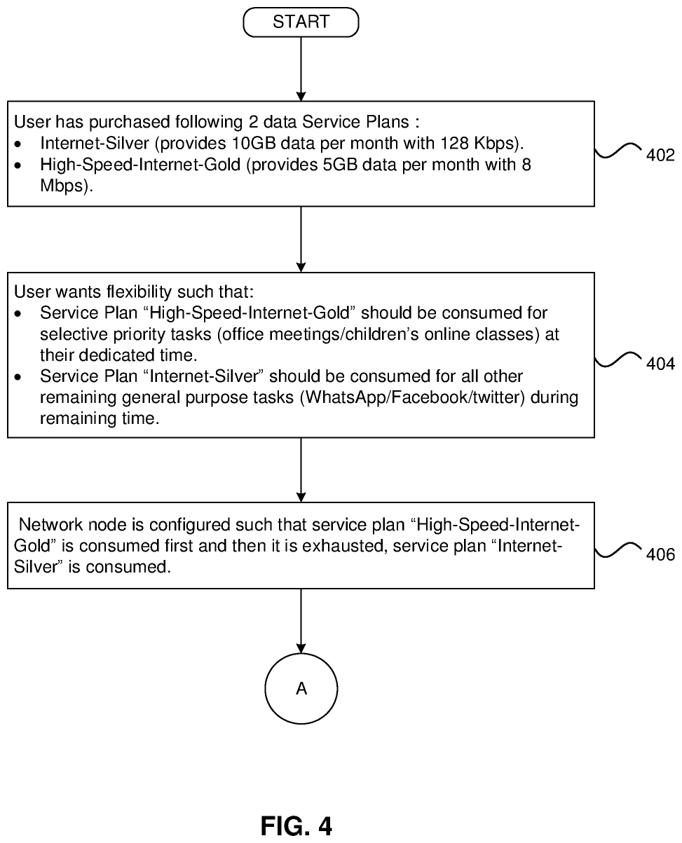

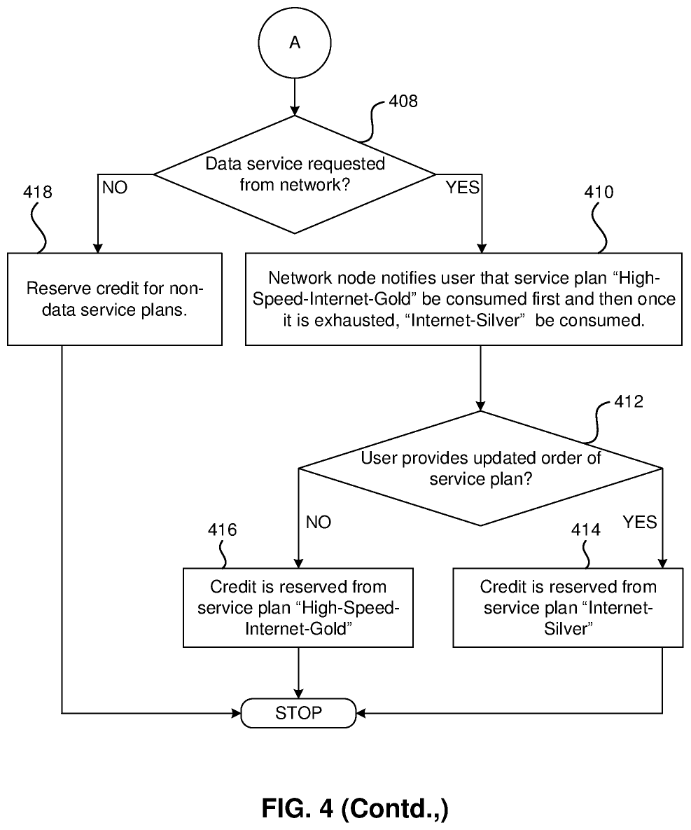

FIG. 4 is a flowchart illustrating an example scenario in which a network node delivers the services in accordance with user selection order according to some embodiments.

The various steps of the flowchart may be performed by the network node present in the CN 106 in FIG. 1 and/or in a CHF in the CN 106 in FIG. 1.

As exemplified at step 402, the user has subscribed or purchased two service plans such as Internet-Silver (provides 10 GB data per month with 128 kbps) and High-Speed-Internet-Gold (provides 5 GB data per month with 8 Mbps) related to a data service.

At step 404, the user intends to have a flexibility in selecting the service plans for charging the user from the selected service plans such that the service plan “High-Speed-Internet-Gold” to be used for selective priority tasks (office meetings/children's online classes) at their dedicated time and the service plan “Internet-Silver” to be used for all other remaining general purpose tasks (such as for Social Network Sites) during remaining time.

At step 406, the network node is configured such that the service plan “High-Speed-Internet-Gold” is used first and then once it is exhausted, the service plan “Internet-Silver” is used for charging the data service.

At step 408, the network node determines whether a data service is requested from the UE. In case, when the network node determines that the data service is requested, at step 410, the network node notifies the UE that the service plan “High-Speed-Internet-Gold” will be used first and then once it is exhausted, the service plan “Internet-Silver” will be used for charging the data service.

In response to the notification of the service plans, the user may select ordering of the service plans where the user may select the service plan “Internet-Silver” to be used first and then the service plan “High-Speed-Internet-Gold” to be used next. Thus, the user may select and/or define the order of the service plans that are to be used for charging the data service.

At step 412, the user provides updated order of the service plans to the network node and the network node receives the updated order of the of the service plans. The user may select ordering of the service plans where the user may select the service plan “Internet-Silver” to be used first and then the service plan “High-Speed-Internet-Gold” to be used next for charging the data service.

Therefore, at step 414, the network node credits the data service from the service plan “Internet-Silver” to be used first and then once it is exhausted, the network node credits the data service from the service plan “High-Speed-Internet-Gold”. Thus, the network node delivers the data service to the user by charging the user in accordance to the user selection order of the service plans.

In case, when the user selection order of the service plans is not received by the network node, then at step 416, the network node utilizes the default order of the service plans for charging the user. Thus at step 416, the network node credits the data service from the service plan “High-Speed-Internet-Gold” to be used first and then the service plan “Internet-Silver” to be used next for charging the data service.

In case, at step 408, when the network node determines that there is no data service requested from the UE, then at step 418, the network node credits the services delivered to the user from non-data service plans subscribed or purchased by the user.

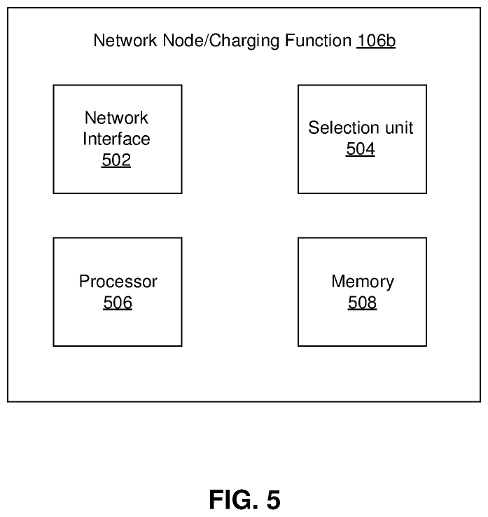

FIG. 5 is a schematic block diagram illustrating an example network node 106b according to some embodiments according to some embodiments.

The network node 106b may be in the form of CHF in the CN 106 as shown in FIG. 1 can be capable of handling charging and/or delivery of the network-delivered services to the UE 102 in FIG. 1.

According to at least some embodiments of the present disclosure, the network node 106b as illustrated in the FIG. 5, may include a network interface 502, a selection unit 504, a processor 506 and a memory 508.

The network interface 502 may be adapted to receive and transmit for example, user data or control signalling to the AN 104 or the CN 106 as shown in FIG. 1.

For example, the network interface 502 may be adapted to receive the service request from the UE, corresponding to the step 202 as illustrated in FIG. 2.

The selection unit 504 may be adapted to notify the one or more service plans subscribed by the user to receive the user selection order from the UE, corresponding to the step 206 as illustrated in FIG. 2 and further, the selection unit 504 may be adapted to receive the user selection order of the service plans from the UE, corresponding to the step 208 as illustrated in FIG. 2.

The processor 506 may be implemented in hardware, software, or a combination of hardware and software to execute one or more instructions to enable and account for service usage (e.g., voice, data, messaging, etc.), and to enable on-demand purchasing of various service plans via a user-interface, UI, of the UE. The memory 508 may store one of more instructions to be executed for initiating the network services and to account for service usage (e.g., voice, data, messaging, etc.) to the UE.

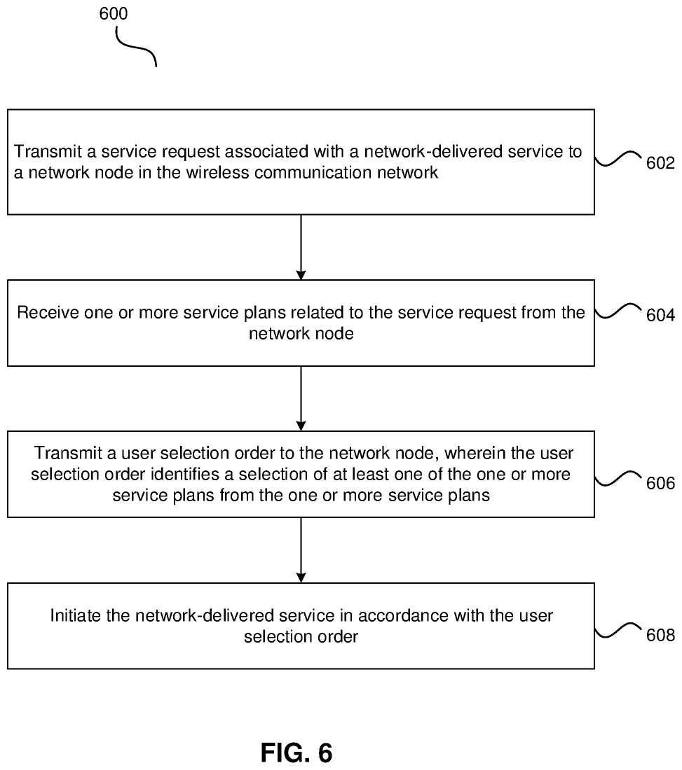

FIG. 6 is a flow chart illustrating example method 600 performed by the UE according to some embodiments.

The method 600 is for selection of service plans for the network-delivered services by the UE. A typical example where the method 600 may be applicable is for service plan selection where the user has subscribed for multiple service plans for a given network service and for example, during the delivery of a service (for example, a video content) to the UE over the wireless communication network.

The network-delivered service can be a subscription based service comprising one or more of a data service, a voice service, a multimedia broadcast multicast service, MBMS, and over-the-top, OTT service, or the like.

In some examples, the method 600 may be applicable when the UE subscribes for user selection order of service plans.

For example, the method 600 may be performed by the UE 102 in FIG. 1.

At step 602, the method 600 comprises transmitting a service request associated with a network-delivered service to a network node in the wireless communication network.

In some examples, the UE transmits the service request through the AF, in the UE. For example, the AF may be a client application or a webpage within the UE which sends the service request from the UE to the network node.

At step 604, the method 600 comprises receiving one or more service plans related to the service request from the network node.

For example, the UE receives the service plans related the service request. The AF within the UE displays or notifies the service plans to the user.

In an embodiment, the UE receives information relating to the one or more service plans in a format suitable for a user interface, UI, of the UE from the network node and the user selection order is transmitted from the UI of the UE to the network node.

In some examples, the one or more service plans received from the network node represents default order of the service plans which are used by the network node for charging the user for accessing the network-delivered services.

Thus, in response to the service request, the UE receives the service plans and/or default ordering of the service plans that are used by the network node for initiating the network-delivered services.

At step 606, the method 600 comprises transmitting a user selection order to the network node. The user selection order identifies a selection of at least one of the one or more service plans from the one or more service plans received from the network node.

In some examples, the one or more service plans or the default ordering of the service plans may be displayed in a UI for receiving the user selection order. The user may select the order of the service plans for crediting or charging the service request from the user selected order of the service plans. Thus, the user selection order from the UE includes a selection of least one service plan from the one or more service plans or an ordering of the service plans to be used for charging the user for the service request.

It should be noted that the user may select a single service plan from a set of service plans to be used for charging the user for the service request or the user may select multiple service plans, or preferably the user may select an order of the service plans according to real-time requirements for charging the user.

At step 608, the method 600 comprises initiating the network-delivered service in accordance with the user selection order.

In some examples, the UE may be charged for the network-delivered services according to the user selection order that includes the order of the service plans and then the network-delivered services are initiated at the UE.

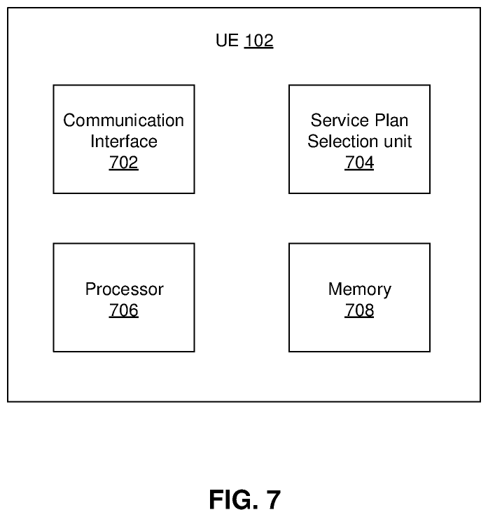

FIG. 7 is a schematic block diagram illustrating an example user equipment according to some embodiments.

According to at least some embodiments of the present disclosure, the network node 106b as illustrated in the FIG. 7, may include a communication interface 702, a service plan selection unit 704, a processor 706 and a memory 708.

The communication interface 702 may be adapted to receive and transmit for example, user data or control signalling from the AN 104 or the CN 106 as shown in FIG. 1.

For example, the communication interface 702 may be adapted to transmit the service request from the UE, corresponding to the step 602 as illustrated in FIG. 6.

The service plan selection unit 704 may be adapted to receive the one or more service plans related to the service request from the network node, corresponding to the step 604 as illustrated in FIG. 6. For example, the service plan selection unit 704 may be adapted to display the received one or more service plans in the UI to the user.

Further, the service plan selection unit 704 may be adapted to receive the user selection order of the service plans in the UI.

In some examples, the communication interface 702 may be adapted to transmit the user selection order to the network node, corresponding to the step 606 as illustrated in FIG. 6.

The processor 706 may be implemented in hardware, software, or a combination of hardware and software to execute one or more instructions to enable and account for service usage (e.g., voice, data, messaging, etc.), and to enable selection of service plans via the UI, of the UE. The memory 708 may store one of more instructions to be executed for selection of service plans for the network-delivered services (e.g., voice, data, messaging, etc.).

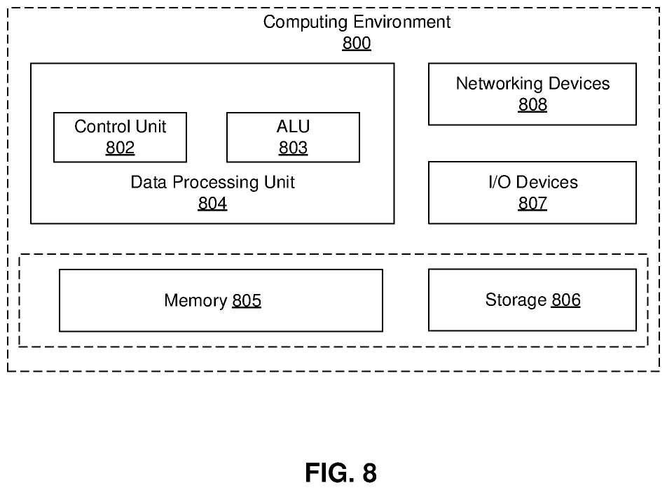

FIG. 8 discloses an example computing environment 800 implementing a method, a network node for handling delivery of network-delivered services to a UE as described in FIGS. 2, 5, 6 and 7. As depicted in FIG. 8, the computing environment 800 comprises at least one data processing unit 804 that is equipped with a control unit 802 and an Arithmetic Logic Unit, ALU 803, a memory 805, a storage 806, plurality of networking devices 808 and a plurality Input output, I/O devices 807. The data processing unit 804 is responsible for processing the instructions of the algorithm. The data processing unit 804 is capable of executing software instructions stored in memory 805. The data processing unit 804 receives commands from the control unit 802 in order to perform its processing. Further, any logical and arithmetic operations involved in the execution of the instructions are computed with the help of the ALU 803.

The overall computing environment 800 can be composed of multiple homogeneous and/or heterogeneous cores, multiple CPUs of different kinds, special media and other accelerators. The data processing unit 804 is responsible for processing the instructions of the algorithm. Further, the plurality of data processing units 804 may be located on a single chip or over multiple chips.

The algorithm comprising of instructions and codes required for the implementation are stored in either the memory 805 or the storage 806 or both. At the time of execution, the instructions may be fetched from the corresponding memory 805 and/or storage 806, and executed by the data processing unit 804.

In case of any hardware implementations various networking devices 808 or external I/O devices 807 may be connected to the computing environment to support the implementation through the networking devices 808 and the I/O devices 807.

The embodiments disclosed herein can be implemented through at least one software program running on at least one hardware device and performing network management functions to control the elements. The elements shown in FIG. 8 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for handling delivery of network-delivered services to a user equipment, UE, in a wireless communication network, the method being performed by at least one network node, wherein the method comprises:
receiving a service request associated with a network-delivered service from the UE;
notifying one or more service plans related to the service request to the UE, in response to the receipt of the service request;
receiving a user selection order from the UE, wherein the user selection order identifies a selection of at least one of the one or more service plans from the one or more service plans; and
initiating the network-delivered service in accordance with the user selection order.

2. The method according to claim 1, wherein the method further comprising:
identifying the one or more service plans related to the service request prior to notifying the one or more service plans, wherein the one or more service plans are associated with network-delivered service(s) subscribed by the UE.

3. The method according to claim 1, wherein the step of notifying one or more service plans related to the service request to the UE comprises:
transmitting information relating to the one or more service plans in a format suitable for a user interface, UI, of the UE; and
wherein the user selection order is received from the UI of the UE.

4. The method according to claim 1, wherein the user selection order further comprises one or more criteria for each user selected service plan, wherein the one or more criteria comprises a bandwidth requirement and/or a time period indicating a number of hours or a time of a day.

5. The method according to claim 1, wherein the method further comprises:
storing the user selection order received from the UE.

6. The method according to claim 1, wherein the network-delivered service is a subscription based service comprising one or more of: a data service, a voice service, a multimedia broadcast multicast service, MBMS, and over-the-top, OTT service.

7. The method according to claim 1, wherein the network node is a network function in a core network, CN, wherein the user selection order from the UE is received via another network node in the wireless communication network.

8. A network node for handling delivery of network-delivered services wireless in a communication network, the network node comprising a processor;
and a memory storing instructions that, when executed by the processor, cause the network node to:
receive a service request associated with a network-delivered service from the UE;
notify one or more service plans related to the service request to the UE, (102) in response to the service request;
receive a user selection order from the UE, wherein the user selection order identifies a selection of at least one of the one or more service plans from the one or more service plans; and
initiate the network-delivered service in accordance with the user selection order.

9. The network node according to claim 8, the network node further configured to:
identify the one or more service plans related to the service request prior to notifying the one or more service plans, wherein the one or more service plans are associated with the network-delivered service subscribed by the UE.

10. The network node according to claim 8, wherein the network node configured to notify one or more service plans related to the service request to the UE:
transmitting information relating to the one or more service plans in a format suitable for a user interface, UI, of the UE; and
wherein the user selection order is received from the UI of the UE.

11. The network node according to claim 8, wherein the user selection order further comprises one or more criteria for each user selected service plan, wherein the one or more criteria comprises a bandwidth requirement and a time period.

12. The network node according to claim 8, wherein the network node further configured to:
store the user selection order received from the UE.

13. The network node according to claim 8, wherein the network-delivered service is a subscription based service comprising one or more of: a data service, a voice service, a multimedia broadcast multicast service, MBMS, and over-the-top, OTT service.

14. The network node according to claim 8, wherein the network node is a network function, in a core network, CN, wherein the network node is configured to receive the user selection order from the UE via another network node in the wireless communication network.

15. A method for handling delivery of network-delivered services, the method being performed by a user equipment, UE in a wireless communication network, wherein the method comprises:
transmit a service request associated with a network-delivered service to a network node in the wireless communication network;
receive one or more service plans related to the service request from the network node, in response to the transmission of the service request;
transmit a user selection order to the network node, wherein the user selection order identifies a selection of at least one of the one or more service plans from the one or more service plans; and
initiating the network-delivered service in accordance with the user selection order.

16. The method according to claim 15, wherein the step of receiving one or more service plans related to the service request from the network node comprises:
receiving information relating to the one or more service plans in a format suitable for a user interface, UI of the UE; and
wherein the user selection order is transmitted from the UI of the UE.

17. The method according to claim 15, wherein the user selection order further comprises one or more criteria for each user selected service plan, wherein the one or more criteria comprises a bandwidth requirement and/or a time period indicating a number of hours or a time of a day.

18. The method according to claim 15, wherein the network-delivered service is a subscription based service comprising one or more of: a data service, a voice service, a multimedia broadcast multicast service, MBMS, and over-the-top, OTT service.

19. A user equipment UE for handling delivery of network-delivered services in a wireless communication network, the UE comprising a processor;
and a memory storing instructions that, when executed by the processor, cause the UE to:
transmit a service request associated with a network-delivered service to a network node in the wireless communication network;
receive one or more service plans related to the service request from the network node, in response to the transmission of the service request;
transmit a user selection order to the network node, wherein the user selection order identifies a selection of at least one of the one or more service plans from the one or more service plans; and
initiate the network-delivered service in accordance with the user selection order.

20. The UE according to claim 19, wherein the UE is adapted for receiving the one or more service plans related to the service request from the network node by:
receiving information relating to the one or more service plans in a format suitable for a user interface, UI of the UE; and
wherein the user selection order is transmitted from the UI of the UE.

21.-23. (canceled)
